(19) United States
(12) Patent Application Publication
(10) Pub. No.: US 2009/0014568 A1
(43) Pub. Date: Jan. 15, 2009

(54) Adaptable shredder housing

(76) Inventor: Tie Chun Wang, Taipei (TW)

Correspondence Address: Venable, 2049 Century Park East, 21st Floor, LOS ANGELES, CA, 90067, US

(21) Appl. No.: 11/827,123

(22) Filed: Jul. 10, 2007

(51) Int. Cl. B02C 18/16

(52) U.S. Cl. 241/285.2

(57) ABSTRACT

The present invention relates generally to adaptable shredder housings which can be placed in or on top of various articles of furniture or waste baskets. Specifically, this invention discloses a shredder housing with at least one safety interlock switch which seamlessly fits into various articles of furniture or with multiple safety interlock switches which can fit over different sized bases or waste baskets.

### BACKGROUND OF THE INVENTION

1. Field of the Invention

The present invention relates generally to adaptable shredder housings which can be placed in or on top of various articles of furniture or waste baskets. Specifically, this invention discloses a shredder housing with at least one safety interlock switch which seamlessly fits into furniture or with multiple safety interlock switches which can fit over different sized waste baskets.

2. Background Information

With increased privacy concerns, shredders have become an integral part in both homes and businesses. Though originally used to destroy paper products, shredders are now used to shred other forms of media that hold information, such as compact discs. In addition, credit cards and other plastic products are commonly shredded.

Conventional shredder housings are made to fit over a waste receptacle or base in which the waste receptacle sits. The housing has a safety interlock switch which is activated when it is placed on the waste receptacle or base. Activation of the safety interlock switch is necessary to turn on the shredder. The purpose of the safety interlock switch is to prevent the shredder from being turned on when the shredder housing is not on the receptacle or base. The safety interlock switch prevents a user from accessing the shredder blades from underneath while the shredder is on.

These conventional shredder housings are only made to fit over the specific sized waste receptacle or base the shredder housing was made for, and thus will not fit over, or in, any other articles of furniture or waste baskets. Accordingly, the present invention seeks to employ various shredder housing and safety interlock switch arrangements which allow for a shredder housing to be placed in or on multiple articles.

One preferred embodiment of the claimed invention provides this by incorporating a safety interlock switch activation appendage in an article of furniture that aligns with the safety interlock switch when the shredder housing is placed in the furniture.

Another preferred embodiment of the claimed invention has multiple safety interlock switches provided around the housing, such that when the housing is removed, the user's hands would be unable to simultaneously activate all safety interlock switches. In addition, a wide channel around the base of the periphery of the shredder housing allows it to fit over different sized bases or waste receptacles.

From the preceding descriptions, it is apparent that the devices currently being used have significant disadvantages and/or limitations. Thus, important aspects of the technology used in the field of invention remain amenable to useful refinement.

### SUMMARY OF THE INVENTION

The present invention relates to an apparatus that satisfies the need for a shredder housing that can fit into different articles of furniture and/or over various sized waste baskets.

In one preferred embodiment, a shredder housing has a safety interlock switch which is engaged when the shredder housing is placed in an article of furniture. The shredder housing may have additional safety interlock switches at different locations so that the shredder housing can be placed into different pieces of furniture.

In another preferred embodiment a shredder housing has at least 3 safety interlock switches provided around the housing which all need to be activated in order for the shredder to turn on. The safety interlock switches are located at positions where it would be impossible for the user's hands to simultaneously activate all of the switches. In addition, a wide channel around the base of the periphery of the shredder housing allows it to fit over different sized bases or waste receptacles.

All of the foregoing operational principles and advantages of the present invention will be more fully appreciated upon consideration of the following detailed description with reference to the drawings.

### BRIEF DESCRIPTION OF THE DRAWINGS

The features and advantages of this invention are better understood with regard to the following drawings, description, and claims. The drawings consist of the following:

FIG. 1 is a perspective view of a shredder in an article of furniture embodying features of this invention.

FIG. 2 is a perspective view of a shredder and article of furniture embodying features of this invention.

FIG. 3 is a side view of a shredder and article of furniture embodying features of this invention.

FIG. 4 is a front view of a shredder and article of furniture embodying features of this invention.

FIG. 5 is a top plan view of a shredder and article of furniture embodying features of this invention.

FIG. 6 is a perspective view of a shredder in an article of furniture embodying features of this invention.

FIG. 7 is a perspective view of a shredder in an article of furniture embodying features of this invention.

FIG. 8 is a side view of a shredder in an article of furniture embodying features of this invention.

FIG. 9 is a perspective view of a shredder in an article of furniture embodying features of this invention.

FIG. 10 is a front view of a shredder in an article of furniture embodying features of this invention.

FIG. 11 is a top plan view of a shredder in an article of furniture embodying features of this invention.

FIG. 12 is a perspective view of a shredder embodying features of this invention.

FIG. 13 is a bottom view of a shredder embodying features of this invention.

FIG. 14 is a bottom view of a shredder embodying features of this invention.

### DETAILED DESCRIPTION OF THE INVENTION

The essential elements of a shredder are comprised of a base or receptacle, a housing, and a shredder mechanism which is located inside the housing. The housing has an opening or throat that leads to the shredding mechanism. Material to be shredded is then fed through the throat and into the shredding mechanism.

This invention discloses a shredder housing with a safety interlock switch which is engaged when the shredder housing is placed in an article of furniture. The article of furniture has a safety interlock switch activation appendage which aligns with the safety interlock switch of the shredder housing. When the shredder housing is placed on or into the furniture, the interlock switch is activated thus allowing the shredder to be turned on. As detailed below, the shredder housing may have additional safety interlock switches at different locations so that the shredder can be turned on, depending on whether the shredder housing is placed onto versus slid into a piece of furniture.

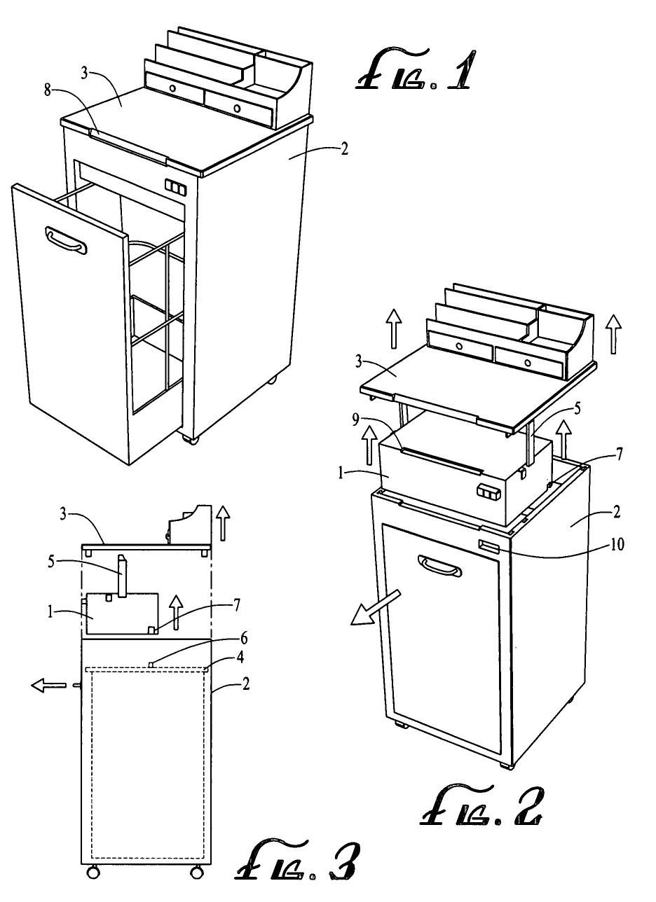

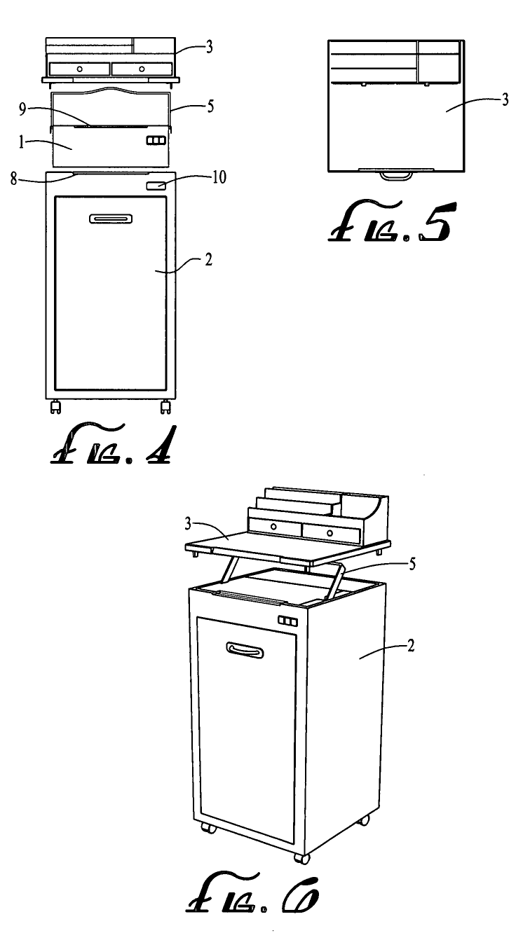

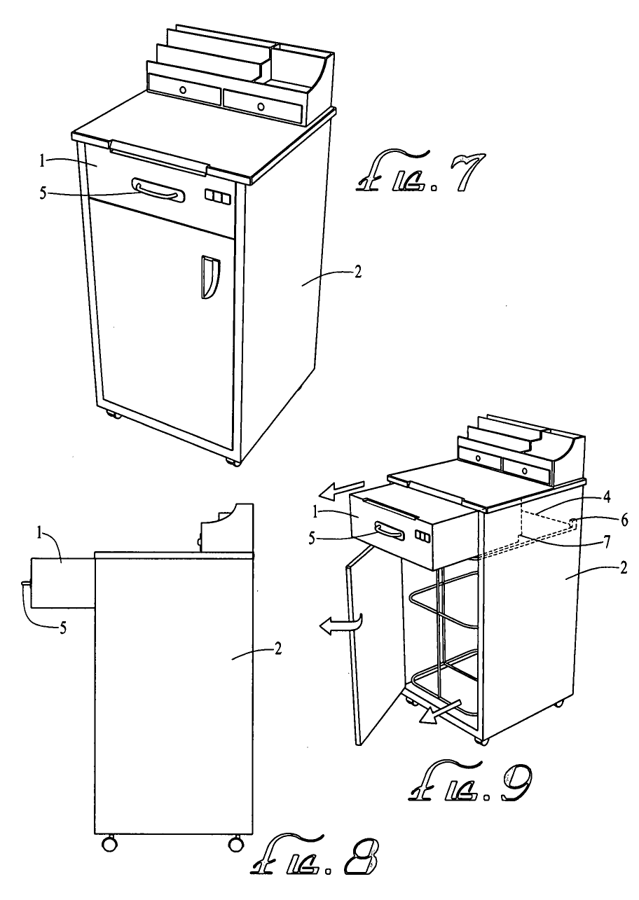

FIGS. 1-12 disclose a preferred embodiment of an adaptable shredder housing. As shown in FIGS. 1-6, a shredder housing 1 can be placed into a piece of furniture 2 from above. By way of example, FIGS. 1-6 show a desk/organizer, with a removable top 3. Once the top 3 is removed, the shredder housing 1 can be placed into the desk from above and on a support 4 in the desk. The shredder housing 1 can have a handle 5 to facilitate insertion and removal of the shredder. The support 4 in the desk has a safety lock switch activation appendage 6 which protrudes above the support 4. The appendage 6 engages the safety interlock switch 7 positioned in the shredder housing 1, thus allowing it to be turned on, when the shredder is placed into the desk. The appendage 6 can be of any shape so long as it is capable of engaging the safety interlock switch 7 when the shredder housing 1 is placed on the support 4.

The safety interlock switch 7 is preferably a small size and shape such that it is not possible for a user to manually engage the switch with his/her hands. It can be of any sort commonly known to those skilled in the art and is thus not described herein.

The desk also has a material opening 8 which aligns with the shredder housing throat 9, thus allowing shredded material to be inserted into the shredder. In addition, the desk has a switch opening 10 through which a user can turn the shredder on or off.

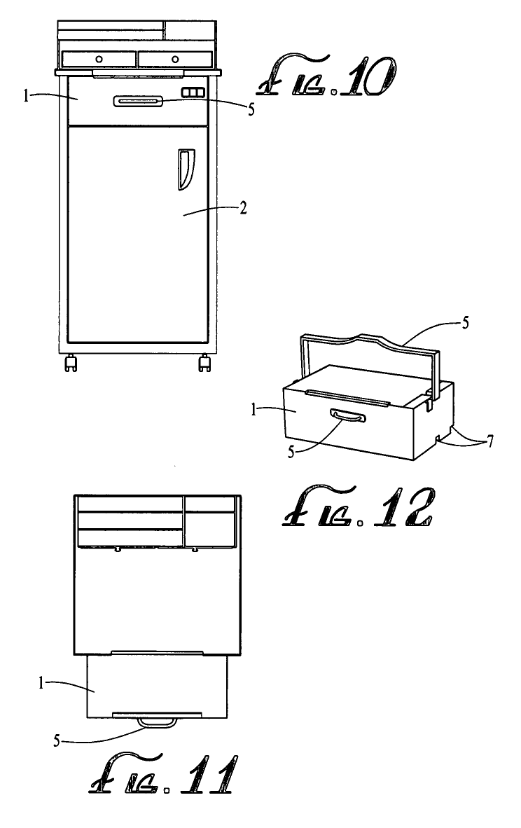

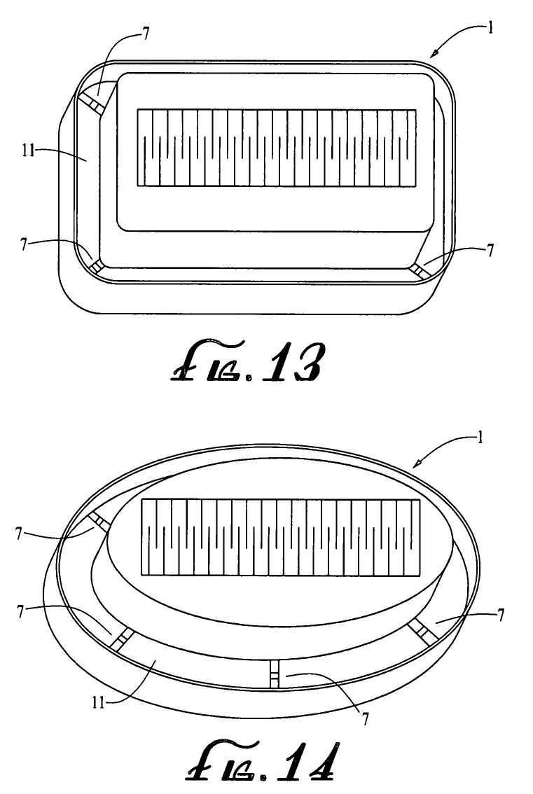

As shown in FIGS. 7-11, a shredder housing 1 can also be placed into a piece of furniture by sliding it in from the side. In this embodiment, the article of furniture again has a safety interlock switch activation appendage 6 which engages the safety interlock switch 7 in the shredder housing. As disclosed in FIG. 9, the safety interlock switch 7 may be placed in the corner of the shredder housing 1 thus allowing it to be engaged from either the side of the shredder housing or from below the shredder housing. Additionally, the shredder housing 1 may have multiple interlock switches 7, as disclosed in FIG. 12, such that the safety interlock switch 7 can be engaged by a safety interlock switch activation appendage 6 from below the shredder housing 1, as well as from a safety interlock switch activation appendage 6 from the side of the shredder housing 1.

It should be appreciated that although this preferred embodiment discloses a specific location for the safety interlock switch and corresponding appendage, any location around the shredder housing may be used for the safety interlock switch such that it can be activated by the corresponding appendage in an article of furniture.

FIGS. 13 and 14 disclose another preferred embodiment in which a shredder housing 1 has multiple safety interlock switches 7 provided in a channel 11 around the periphery of the shredder housing 1. In order for a user to turn the shredder on, all safety interlock switches 7 need to be engaged at the time the shredder is turned on. In addition, the shredder will turn off if any safety interlock switch 7 is not engaged. These mechanisms are readily known to those skilled in the art, and are thus not described herein.

The safety interlock switches 7 are located at positions where it would be impossible for a user's hands to simultaneously activate all of the switches. Preferably there are at least 3 safety interlock switches 7. The channel 11 around the periphery of the shredder housing is of a sufficient width such that the shredder housing 1 can fit over various sized bases or waste receptacles.

It should be appreciated that although this preferred embodiment discloses a channel with an equal width around the periphery, other widths can be utilized in order to accommodate a greater variety of bases or waste receptacles.

Although the present invention has been described in detail with respect to certain preferred versions thereof, other versions are possible. Therefore, the scope of the claims should not be limited to the description of the preferred versions contained herein.

1. An adaptable shredder housing comprised of:
(a) a shredding mechanism located inside the shredder housing;
(b) a throat through which material to be shredded is fed into the shredding mechanism; and
(c) at least one safety interlock switch positioned in the shredder housing;
(b) said safety interlock switch capable of being engaged from a safety interlock switch activation appendage from either the side of the shredder housing or from below the shredder housing.

2. An adaptable shredder housing comprised of:
(a) a shredding mechanism located inside the shredder housing;
(b) a throat through which material to be shredded is fed into the shredding mechanism;
(c) at least one safety interlock switch positioned in the shredder housing capable of being engaged from a safety interlock switch activation appendage from below the shredder housing; and
(d) at least one safety interlock switch capable of being engaged from a safety lock switch activation appendage from the side of the shredder housing.

3. An adaptable shredder housing comprised of:
(a) a shredding mechanism located inside the shredder housing;
(b) a throat through which material to be shredded is fed into the shredding mechanism;
(c) a channel around the periphery of the shredder housing;
(d) at least 3 interlock safety switches positioned in said channel;
(e) said interlock safety switches only capable of turning on the shredding mechanism when all interlock safety switches are engaged.
